(19) United States
(12) Patent Application Publication
(10) Pub. No.: US 2013/0297256 A1
(43) Pub. Date: Nov. 7, 2013

(54) Method and System for Predictive and Conditional Fault Detection

(71) Applicant: Jun Yang, Richmond, VA (US)

(72) Inventor: Jun Yang, Richmond, VA (US)

(21) Appl. No.: 13/464,476

(22) Filed: May 4, 2012

(51) Int. Cl. G06F 15/00

(52) U.S. Cl. 702/183

(57) ABSTRACT

A method and system for predictive and conditional fault detection that utilizes a machine's characteristics and sensor detected faults to predict and diagnose future faults. The fault detection method utilizes machine characteristics and fault sensors on the machines to generate extracted vectors. The two types of vectors are combined into an extracted vector. The extracted vector is stored in a machine state database and a fault symptom database. The databases utilize this information for future machine condition evaluation and maintenance suggestions. The information in the databases is mined to provide optimal fault detection suggestions by comparing vectors from the databases. Additional fault inspections, machine fault information, and comparisons between machine vectors and fault vectors further refine the fault vectors for optimal diagnoses. The resultant fault detection generates additional useful fault information, which is added to the database to further refine the fault detection method and system.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fault detection. More particularly, one or more embodiments of the invention relate to condition based maintenance systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that faults in machinery often results from stress on materials, extended use of machinery, vibrations, misalignments, loose components, and poor foundation. The faults may be characteristic of regular operation of the equipment. Machine faults may be quantified with sensors, such as an accelerometer to measure vibration waveforms, and vibration analyzers can also be utilized to obtain frequency and amplitude information about the vibrations that are present. These measurements are used to diagnose machinery faults.

Monitoring and maintenance of mechanical machinery can be expensive and can result in unnecessary downtime for performing monitoring and maintenance.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an operational flow diagram of an example condition based maintenance system, in accordance with an embodiment of the present invention;

FIG. 2 is a block diagram of a system with a machine and an example condition based maintenance system, in accordance with an embodiment of the present invention;

FIG. 3 illustrates an example method for the condition based maintenance system as described with reference to FIGS. 1-2, in accordance with an embodiment of the present invention; and

FIG. 4 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A condition based maintenance system will be described which provides means and methods for detecting faults associated with machinery. The system generates and uses feature vectors associated with machinery components for determining fault conditions with the components.

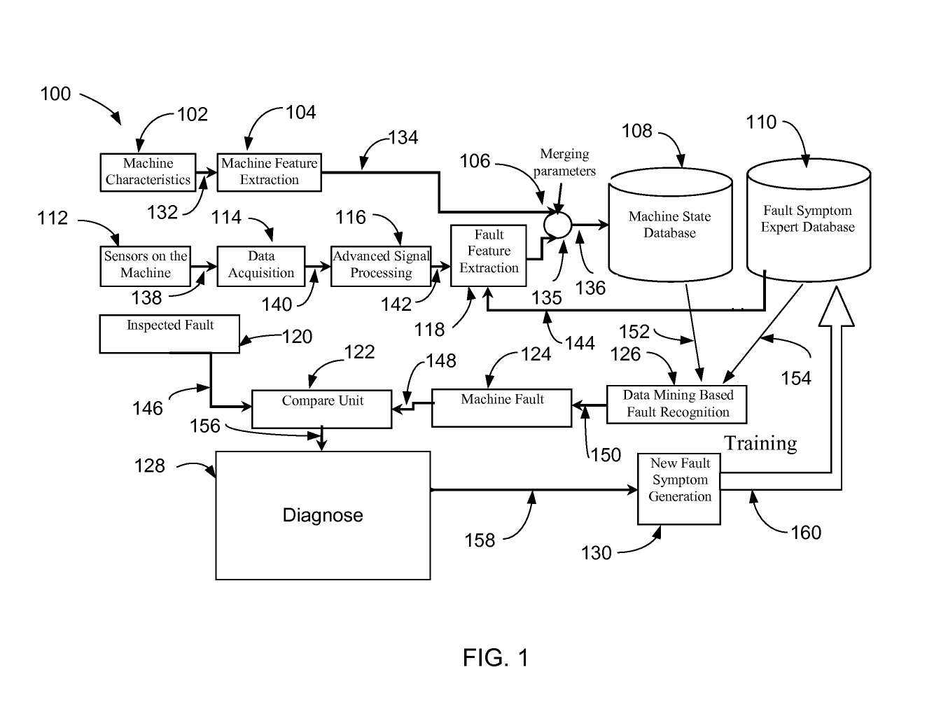

The system will now be described in detail with reference to FIGS. 1-4.

FIG. 1 is an operational flow diagram of an example condition based maintenance system, in accordance with an embodiment of the present invention

An operational flow diagram 100 includes a machine characteristics operation 102, a machine feature extraction operation 104, a merge operation 106, a machine state database 108, a fault symptom expert database 110, a sensing operation 112, a data acquisition operation 114, a signal processing operation 116, a fault feature extraction operation 118, an inspected fault operation 120, a compare operation 122, a machine fault operation 124, a data mining operation 126, a diagnose operation 128 and a new fault symptom generation operation 130.

Machine feature extraction operation 104 receives information from machine characteristics operation 102 via a communication channel 132. Merge operation 106 receives information from machine feature extraction operation 104 via a communication channel 134. Data acquisition operation 114 receives information from sensing operation 112 via a communication channel 138. The merge operation 106 also receives information from fault feature extraction operation 118 via a communication channel 135. Machine state database 108 receives information from merge operation 106 via a communication channel 136. Signal processing operation 116 receives information from data acquisition operation 114 via a communication channel 140. Fault feature extraction operation 118 receives information from signal processing operation 116 via a communication channel 142 and receives information from fault symptom expert database 110 via a communication channel 144. Compare operation 122 receives information from inspected fault operation via a communication channel 146 and from machine fault operation 124 via a communication channel 148. Machine fault operation 124 receives information from data mining operation 126 via a communication channel 150. Data mining operation 126 receives information from machine state database 108 via a communication channel 152 and receives information from fault symptom expert database 110 via a communication channel 154. Diagnose operation 128 receives information from compare operation 122 via a communication channel 156. New fault symptom generation operation 130 receives information from diagnose operation 128 via a communication channel 158. Fault symptom expert database 110 receives information from new fault symptom generation operation 130 via a communication channel 160.

Machine characteristics operation 102 generates characteristics associated with a machine. The machine characteristics may represent the historical fault expectations for a specific machine. Machine feature extraction operation 104 extracts feature vectors associated with the machine. In one embodiment, feature vectors may be of any known type of feature vector.

Sensing operation 112 converts mechanical information to electrical information. Data acquisition operation 114 receives electrical information from the sensors and converts the electrical information to digital information. In an alternative embodiment, the number of sensors and the number of machines are not equal. Those skilled in the art, in light of the present teachings, can appreciate that the sensors are operatively joined to the machine and may include, but are not limited to an accelerometer to measure vibration waveforms, and vibration analyzers to obtain frequency and amplitude information about the vibrations that are present. This information is efficacious for determining faults in machinery.

Signal processing operation 116 processes received information such that it may be processed for feature vector extraction. Fault feature extraction operation 118 performs feature vector extraction. Merge operation 106 performs a merge of machine feature vectors and fault failure vectors into extraction vectors. Machine state database 108 stores and retrieves information associated with merged feature vectors. Fault symptom expert database 110 stores and retrieves information associated with detected faults. Those skilled in the art, in light of the present teachings, can appreciate that Machine state database 108 provides data feature extraction suggestions for predicting faults in a machine. Fault symptom expert database 110 provides future references for extraction vectors.

Inspected fault operation 120 provides inspected fault information. Data mining operation 126 receives and processes information for generating fault associated feature vectors. Those skilled in the art can appreciate that the process of mining data from Machine state database 108 and Fault symptom expert database 110 may require comparing a current machine feature vector with a machine feature vector from Machine state database and Fault symptom expert database. Mining data from said machine state database and said fault symptom expert database may also require selecting an appropriate processing based upon an associated condition and providing a suggestion for providing maintenance to the fault in the machine.

Machine fault operation 124 provides feature vectors associated with machine faults. Compare operation 122 performs a compare operation between current feature vector information and prior processed feature vector information associated with detected faults. Diagnose operation 128 performs a diagnoses as to whether a received feature vector matches a fault feature vector. New fault symptom generation operation 130 performs processing for training associated with generation of fault feature vectors. However, if no faults are diagnosed, no training may occur.

For machine characteristics operation 102, machine characteristics are analyzed, and machine components are categorized into feature vectors. Non-limiting examples of parameters associated with feature vectors include gearbox-gearbox type number of input teeth and number of output teeth. A component associated with a machine has a unique feature vectors or set of associated feature vectors.

For signal processing operation 116, raw sensor signals are processed in order to increase machine fault signal-to-noise ratio.

For fault feature extraction operation 118, the preprocessed data is searched using pre-existing knowledge based upon machine features associated with extracted features and/or user-defined parameters.

For merge operation 106, the machine feature vectors are combined with extracted fault features, forming new vectors. The combined feature vectors are then stored for additional processing and referencing. As a non-limiting example, combined feature vector includes machine type, component type, component parameters, fault type and extracted fault features. Furthermore, one machine component may correspond to a multiplicity of combined feature vectors.

Machine state database 108 stores the current machine data feature vectors and machine feature vectors with unknown machine states.

Fault symptom expert database 110 stores the typical machine fault features (combined vectors). Furthermore, the machine fault feature vectors are used to train the data mining based fault recognition system. When unknown faults are detected, new fault feature vectors are updated to the expert database.

For data mining based fault recognition operation, the machine feature vectors, combined with extracted data feature vectors, are treated as input to the trained data mining models in the database.

Compare operation 122 compares the automated machine fault recognition results with the true inspected machine fault. If the automated machine fault recognition fails to correctly identify the true machine faults, the combined vectors are added to Fault system expert database 110.

In operation, characteristics associated with a machine are used for generating feature vectors. Furthermore, machine feature vectors are combined with feature vectors generated from receiving and processing information from sensors associated with a machine. The combined feature vector information is stored in a database in order to be retrieved for further processing and in order to perform a comparison for detecting a fault condition.

FIG. 1 is an operational flow diagram of an example condition based maintenance system where information is processed for generating fault feature vectors, with the fault feature vectors compared to component feature vectors in order to determine a fault condition.

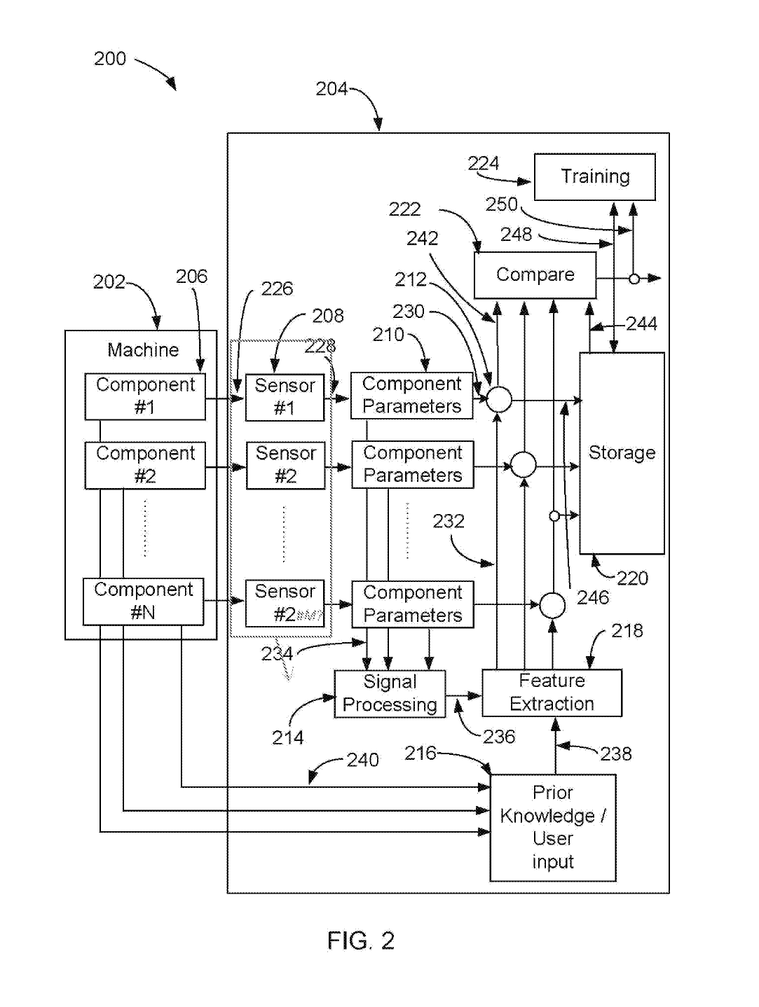

FIG. 2 is a block diagram of a system with a machine and an example condition based maintenance system, in accordance with an embodiment of the present invention.

A system 200 includes a machine 202 and a condition based maintenance system 204.

Machine 202 includes a multiplicity of components with a sampling noted as a component 206. Non-limiting examples for component 206 include bearings, gears and mechanical transmission devices.

Condition based maintenance system 204 includes a multiplicity of sensors with a sampling noted as a sensor portion 208, a multiplicity of component parameter portions with a sampling noted as a component parameters portion 210, a multiplicity of merging portions with a sampling noted as a merging portion 212, a signal processing portion 214, a user input portion 216, a feature extraction portion 218, a storage portion 220, a compare portion 222 and a training portion 224.

Sensor portion 208 receives information from component 206 via a communication channel 226. Component parameters portion 210 receives information from sensor portion 208 via a communication channel 228. Merging portion 212 receives information from component parameters portion 210 via a communication channel 230 and from feature extraction portion 218 via a communication channel 232. Signal processing portion 214 receives information from component parameters portion 210 via a communication channel 234. Feature extraction portion 218 receives information from signal processing portion 214 via a communication channel 236 and receives information from user input portion 216 via a communication channel 238. User input portion 216 receives information from component 206 via a communication channel 240. Compare portion 222 receives information from merging portion 212 via a communication channel 242 and receives information from storage portion 220 via a communication channel 244. Storage portion 220 receives information from merging portion 212 via a communication channel 246. Training portion 224 communicates bi-directionally with storage portion 220 via a communication channel 248 and receives information from compare portion 222 via a communication channel 250. Compare portion 222 provides information to external entities (not shown) via communication channel 250.

Machine 202 provides a mechanical operation or service. Component 206 performs an operation associated with machine 202. Sensor portion 208 converts mechanical information to electrical information. Component parameters portion 210 receives electrical information and communicates digital information associated with the received electrical information. Merging portion 212 receives and merges processed component information and feature vector information to generate combined feature vector information. Signal processing portion 214 receives and processes component related information such that is may be processed for feature extraction. User input portion 216 receives and processes information associated with machine components such that the information may be processed for feature extraction. Feature extraction portion 218 receives information and performs feature extraction. Storage portion 220 receives, stores and retrieves information. Compare portion 222 performs a comparison between feature vectors and prior generated fault feature vectors for determining is a fault condition exists. Training portion 224 performs training for generating fault feature vectors.

Condition based maintenance system 204 enables combination of machine feature vectors and data feature vectors for generating an extracted feature vector set. User input portion 216 enables the transfer of human machine fault diagnostic knowledge to a searchable database by confirming/revising diagnostic results. Data feature vector extraction suggestions may be provided based upon a search using machine features with existing vectors.

By using data mining techniques, the system categorizes the feature vectors. The system compares current machine feature vectors with ones in the database and selects the appropriate processing to perform based upon the associated conditions and provides suggestions with respect to performing maintenance.

The system provides capability for improving maintenance associated with mechanical machinery. Furthermore, the function of the system may be performed via any known computer system operating any known operating system.

In operation, characteristics associated with a machine are used for generating feature vectors. Furthermore, the machine feature vectors are combined with feature vectors generated from receiving and processing information from sensors associated with a machine. The combined feature vector information is stored in order to be retrieved for further processing and in order to perform a comparison for detecting a fault condition.

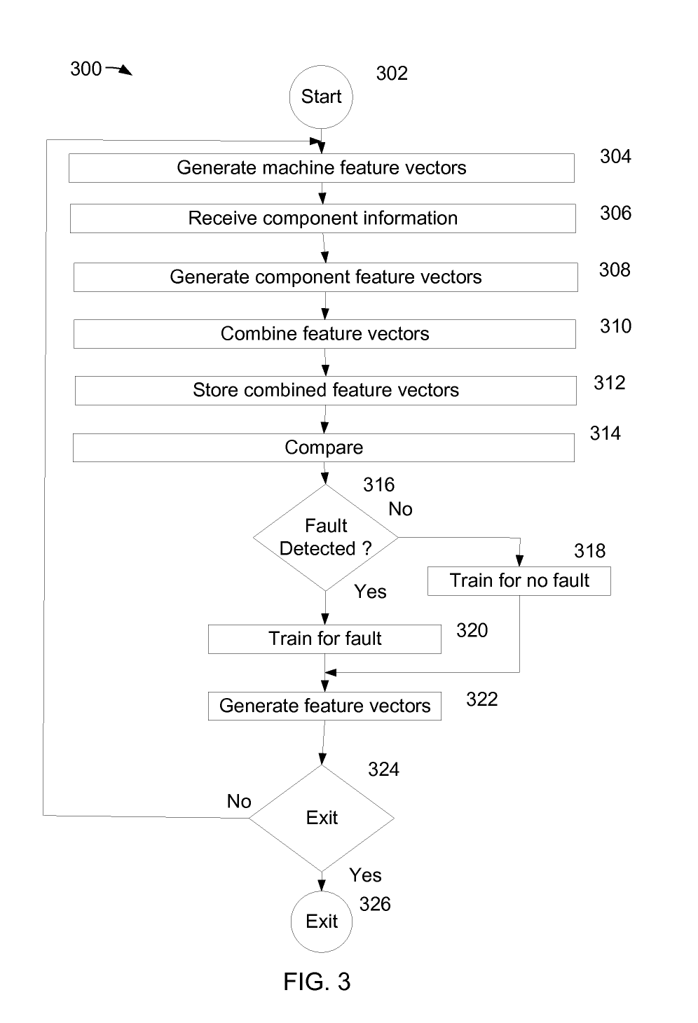

A method of performing the operation of the condition based maintenance system as described with reference to FIGS. 1-2 will now be described with reference to FIG. 3.

FIG. 3 illustrates an example method for the condition based maintenance system as described with reference to FIGS. 1-2, in accordance with an embodiment of the present invention.

Referring to FIG. 3, a method 300 initiates in a step 302.

Then in a step 304, machine feature vectors are generated.

Machine feature vectors are generated as described with reference to machine feature extraction operation 104 (FIG. 1).

Referring back to FIG. 3, then in a step 306, component information is received.

Mechanical component information is received and converted to electrical information as described with reference to sensing operation 112 (FIG. 1) and data acquisition operation 114 (FIG. 1).

Referring back to FIG. 3, then in a step 308, feature vectors for components are generated.

Feature vectors for components are generated as described with reference to signal processing operation 116 (FIG. 1) and fault feature extraction operation 118 (FIG. 1).

Referring back to FIG. 3, then in a step 310 feature vectors are combined.

Feature vectors are combined as described with reference to merge operation 106 (FIG. 1).

Referring back to FIG. 3, then in a step 312 combined feature vectors are stored.

Combined feature vectors are stored as described with reference to machine state database 108 (FIG. 1).

Referring back to FIG. 3, then in a step 314 feature vectors are compared.

Feature vectors are compared as described with reference to compare operation 122 (FIG. 1).

Referring back to FIG. 3, then in a step 316 a determination for detecting a fault is performed.

A determination for detecting a fault is performed as described with reference to compare operation 122 (FIG. 1).

Referring back to FIG. 3, for a determination of detecting a fault in step 316, in a step 318, training is performed for a no fault condition.

For a determination of not detecting a fault, training is performed for a not fault condition as described with reference to new fault symptom generation operation 130 (FIG. 1).

Referring back to FIG. 3, for a determination of detecting a fault in step 316, in a step 320, training is performed for a fault condition.

For a determination of detecting a fault, training is performed for a fault condition as described with reference to new fault symptom generation operation 130 (FIG. 1).

Referring back to FIG. 3 then in a step 322 feature vectors are generated.

Feature vectors are generated as described with reference to data mining operation 126 (FIG. 1) and machine fault operation 124 (FIG. 1).

Referring back to FIG. 3 then in a step 324 a determination for exiting method 300 is performed.

For a determination of not exiting method 300 in step 324, execution of method 300 transitions to step 304.

For a determination of exiting method 300 in step 324, execution of method 300 terminates in a step 326.

FIG. 3 illustrates an example method for the condition based maintenance system as described with reference to FIGS. 1-2 where machine feature vectors are generated, component information is received and processed, component feature vectors are generated, feature vectors are combined, combined feature vectors are stored, feature vectors are compared, detection for a fault is performed, training is performed and feature vectors are generated.

A condition based maintenance system and method for has been presented. The system and method provides for generating and comparing feature vectors for determination of a fault condition.

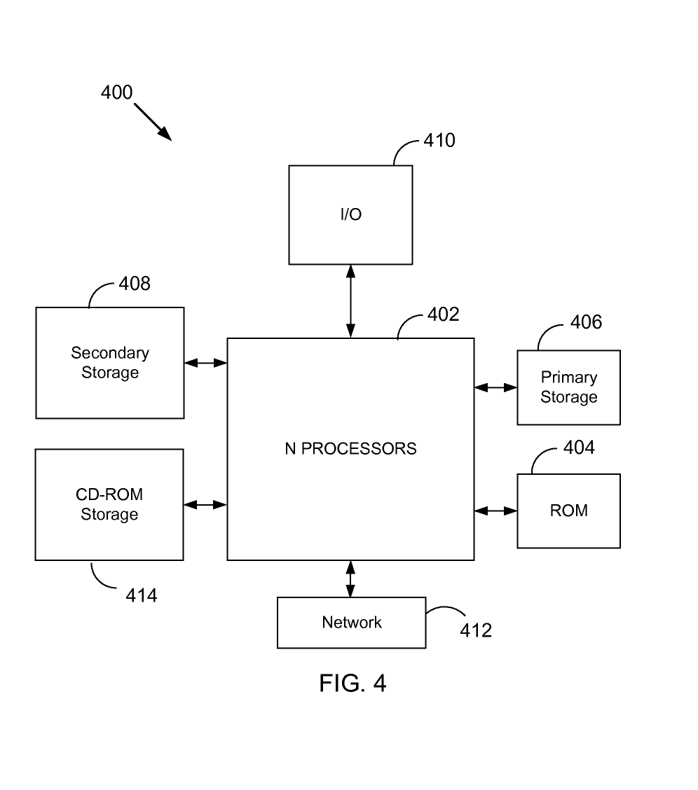

FIG. 4 illustrates a typical computer system that, when appropriately configured or designed, may serve as a computer system 400 for which the present invention may be embodied.

Computer system 400 includes a quantity of processors 402 (also referred to as central processing units, or CPUs) that may be coupled to storage devices including a primary storage 406 (typically a random access memory, or RAM), a primary storage 404 (typically a read-only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 404 acts to transfer data and instructions uni-directionally to the CPU and primary storage 406 typically may be used to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and typically may be used as a secondary storage medium such as a hard disk. It will be appreciated that the information retained within mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of condition based maintenance systems according to the present invention will be apparent to those skilled in the art. The invention has been described above by way of illustration, and the specific embodiments disclosed are not intended to limit the invention to the particular forms disclosed. For example, the particular implementation of the data acquisition portions may vary depending upon the particular type machine used. The data acquisition portions described in the foregoing were directed to rotary machine implementations; however, similar techniques for non-rotary machine implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method for detecting at least one fault comprising the steps of:
(a) generating a machine feature vector;
(b) receiving component information;
(c) generating a component feature vector;
(d) combining said machine feature vector with said component feature vector;
(e) storing combined feature vectors;
(f) comparing combined feature vectors;
(g) if fault detected, training for fault;
(h) if no fault detected, training for no fault; and
(i) generating future vectors.

2. The method of claim 1, in which step (a) further comprises obtaining a machine characteristic.

3. The method of claim 2, in which step (a) further comprises extracting a machine feature vector from said machine characteristic.

4. The method of claim 3, in which step (c) further comprises operatively joining a sensor to a machine.

5. The method of claim 4, in which step (c) further comprises acquiring data from said sensor.

6. The method of claim 5, in which step (c) further comprises processing data from said sensor.

7. The method of claim 6, in which step (c) further comprises extracting a component feature vector.

8. The method of claim 7, wherein step (d) combination of said machine feature vector with said component feature vector generates an extraction vector, said extraction vector being operable to update a database and provide training for predicting a future fault.

9. The method of claim 8, in which step (e) further comprises storing and retrieving said machine feature vector and said component feature vector in a machine state database.

10. The method of claim 9, in which step (e) further comprises storing and retrieving said component feature vector in a fault symptom expert database.

11. The method of claim 10, in which step (e) further comprises mining data from said machine state database and said fault symptom expert database.

12. The method of claim 11, wherein said mining data from said machine state database and said fault symptom expert database comprises comparing a current machine feature vector with said machine feature vector, said mining data from said machine state database and said fault symptom expert database further comprises selecting an appropriate processing based upon at least one associated condition and providing at least one suggestion for providing maintenance to said at least one fault.

13. The method of claim 12, in which step (f) further comprises providing a machine feature vector to a compare unit.

14. The method of claim 13, in which step (f) further comprises providing inspected fault information to said compare unit.

15. The method of claim 14, in which step (f) further comprises comparing machine fault information with inspected fault information in said compare unit.

16. The method of claim 15, in which step (f) further comprises diagnosing whether a received feature vector matches a fault feature vector.

17. The method of claim 16, wherein said step (f) diagnosis results update said fault symptom expert database and provide training for predicting said future fault.

18. The method of claim 17, in which step (i) further comprises processing for training associated with generation of fault feature vectors.

19. A system for detecting at least one fault comprising:
means for generating a machine feature vector;
means for receiving component information;
means for generating a component feature vector;
means for combining said machine feature vector with said component feature vector;
means for storing combined feature vectors;
means for comparing combined feature vectors;
means for training for fault, if fault detected;
means for training for no fault, if no fault detected; and
means for generating future vectors.

20. A computer program product comprising:
(a) computer code for generating a machine feature vector;
(b) computer code for obtaining a machine characteristic;
(c) computer code for extracting a machine feature vector;
(d) computer code for operatively joining a sensor to a machine;
(e) computer code for acquiring data from said sensor;
(f) computer code for processing data from an electrical signal;
(g) computer code for extracting a component feature vector;
(h) computer code for receiving component information;
(i) computer code for generating a component feature vector;
(j) computer code for combining said machine feature vector with said component feature vector;
(k) computer code for storing combined feature vector in a machine state database;
(l) computer code for storing combined feature vector in a fault symptom expert database;
(m) computer code for mining said machine state database and fault symptom expert database;
(n) computer code for providing inspected fault information;
(o) computer code for comparing combined feature vectors;
(p) computer code for training for fault, if fault detected;
(q) computer code for training for no fault, if no fault detected; and
(r) computer code for generating future vectors.
